(19) United States
(12) Patent Application Publication
(10) Pub. No.: US 2014/0354101 A1
(43) Pub. Date: Dec. 4, 2014

(54) ELECTRIC MOTOR

(71) Applicants: Takashi Goto, Tokyo (JP); Hideaki Arita, Tokyo (JP); Kanji Shinkawa, Tokyo (JP); Akihiro Daikoku, Tokyo (JP)

(72) Inventors: Takashi Goto, Tokyo (JP); Hideaki Arita, Tokyo (JP); Kanji Shinkawa, Tokyo (JP); Akihiro Daikoku, Tokyo (JP)

(73) Assignee: MITSUBISHI ELECTRIC CORPORATION, Tokyo (JP)

(21) Appl. No.: 14/373,379

(22) PCT Filed: Apr. 10, 2012
(86) PCT No.: PCT/JP2012/002486

§ 371 Date: Jul. 21, 2014

(51) Int. Cl. H02K 1/27

(52) U.S. Cl. CPC H02K 1/2726; H02K 2201/12
USPC 310/156.02

(57) ABSTRACT

A rotor is formed with a partition wall interposed between a first magnetic body and a second magnetic body. Projections of the partition wall block gaps between salient poles of the first magnetic body and salient poles of the second magnetic body which are arranged at shifted positions when seen in an axial direction of a rotating shaft to shield a flow of air flowing in the axial direction. Notches are formed in parts other than the gaps to decrease a volume thereof and to reduce inertia thereof.

### TECHNICAL FIELD

The present invention relates to a magnetic inductor type electric motor in which the core of a rotor is formed of a magnetic body such as iron.

### BACKGROUND ART

An electric motor that rotatively drives the turbines of an electric compressor, an electrically-assisted turbocharger, and the like desirably has low inertia and high torque because a short acceleration time and a high-speed rotation thereof are required.

Thus, an electric motor disclosed in Patent Document 1, for example, includes: a rotor including first and second magnetic bodies arranged in a rotating shaft with salient poles shifted from each other; a partition wall interposed closely to each other between the first and second magnetic bodies; a stator including stator cores that surround the first and second magnetic bodies, respectively, and a torque generating driving coil that generates rotational torque in the rotor; and a field magnetomotive force generating coil arranged in the stator to excite the salient poles of the rotor; it is thus configured that when the field magnetomotive force generating coil creates magnetic poles in the salient poles of the rotor, and the torque generating driving coil creates magnetic poles in the salient poles of the stator cores, S poles and N poles are switched by switching energization to the torque generating driving coil to thus generate the rotational torque. In this manner, because a member problematic in centrifugal force such as a permanent magnet is not used in the rotor, it is possible to improve a centrifugal force resistant performance at a high-speed rotation. In addition, since the partition wall is provided between the first and second magnetic bodies, a flow of air in a direction of the rotating shaft can be blocked to reduce a windage loss thereof; thus, a motor efficiency thereof can be enhanced.

### PRIOR ART DOCUMENT

### Patent Document

Patent Document 1: Japanese Unexamined Patent Application Publication No. 2009-5572

### SUMMARY OF THE INVENTION

### Problems to be Solved by the Invention

In the above Patent Document 1, there are advantages such that the arrangement of the partition wall gives reduction of the windage loss and torque improvement, while there is a problem such that the volume of the rotor is increased by the partition wall in a trade-off fashion to thus increase inertia thereof.

The present invention is made to solve the foregoing problem and an object of the invention is to provide an electric motor that reduces the inertia without impairing a windage loss reduction effect of the partition wall.

### Means for Solving the Problems

An electric motor of the present invention includes: a rotor including a first magnetic body having salient poles provided protrusively at an equal angular pitch in a circumferential direction on an outer circumference of a cylindrical base having a rotating shaft insertion hole at an axial center position, a second magnetic body having approximately the same shape as the first magnetic body, and arranged coaxially with each other's salient poles shifted in the circumferential direction and separated by a predetermined gap in an axial direction, and a partition wall which is a plate-like member having a rotating shaft insertion hole and which is interposed closely to each other between the first magnetic body and the second magnetic body; a rotating shaft fixed the first magnetic body, the second magnetic body, and the partition wall with inserted into the respective rotating shaft insertion holes; and a stator including a stator core that surround the first and second magnetic bodies, a field magnetomotive force generating unit that excites the salient poles of the rotor, and a torque generating driving unit that generates rotational torque in the rotor, and the partition wall is configured to have a hole or a notch formed in a part other than a region sandwiched between the salient poles of the first magnetic body and the salient poles of the second magnetic body which are arranged at shifted positions when seen in the axial direction.

### Effect of the Invention

According to the present invention, since the hole or notch is formed in the partition wall, it is possible to decrease the volume thereof and to reduce the inertia. On the other hand, since the partition wall is present in the region sandwiched between the salient poles of the first and second magnetic bodies arranged at the shifted position when seen in the axial direction, it is possible to shield a flow of air flowing in the axial direction from the first magnetic body to the second magnetic body through a gap between the salient poles and to reduce a windage loss thereof. Thus, it is possible to provide an electric motor which reduces the inertia without impairing the windage loss reduction effect of the partition wall.

### BRIEF DESCRIPTION OF THE DRAWINGS

FIG. 1 is a partially cutaway perspective view illustrating a configuration of an electric motor according to Embodiment 1 of the present invention.

FIG. 2 illustrates an example of a rotor of the electric motor according to Embodiment 1: FIG. 2(a) is a perspective view of the rotor; and FIG. 2(b) is a plan view of a partition wall.

FIG. 3 illustrates an example of a conventional rotor: FIG. 3(a) is a perspective view of the rotor; and FIG. 3(b) is a plan view of a partition wall.

FIG. 4 is a graph illustrating results that measure torque-to-inertia ratios with partition walls having different shapes.

FIG. 5 illustrates a modification of the partition wall of Embodiment 1: FIG. 5(a) is a perspective view of a rotor; and FIG. 5(b) is a plan view of a partition wall.

FIG. 6 illustrates a modification of the partition wall of Embodiment 1: FIG. 6(a) is a perspective view of a rotor; and FIG. 6(b) is a plan view of a partition wall.

FIG. 7 illustrates a reference example for explaining Embodiment 1: FIG. 7(a) is a cross-sectional view of the rotor, and FIG. 7(b) is a view as seen from an arrow A.

FIG. 8 illustrates a modification of the partition wall illustrated in FIG. 2, and is a perspective view of a rotor to which the modified partition wall is applied.

FIG. 9 is a plan view illustrating a modification of the partition wall illustrated in FIG. 2.

FIG. 10 is a plan view illustrating a modification of the partition wall illustrated in FIG. 2.

### EMBODIMENTS OF THE INVENTION

In the following, in order to describe the present invention in more detail, embodiments for carrying out the invention will be described with reference to the accompanying drawings.

### Embodiment 1

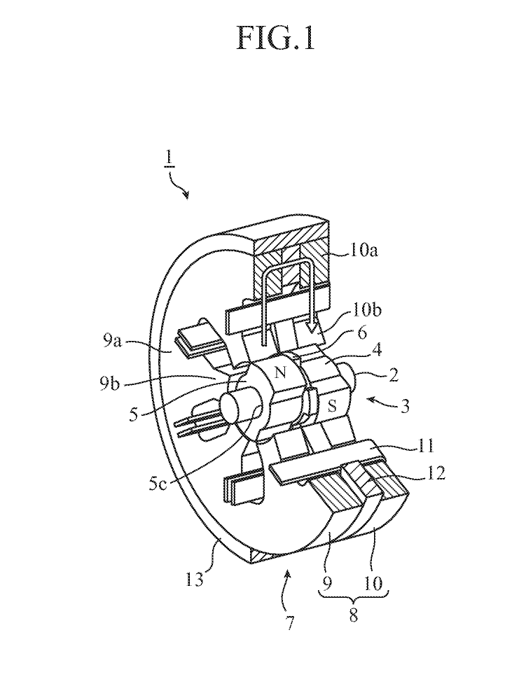

As illustrated in FIG. 1, a magnetic inductor type electric motor (hereinafter, referred to as electric motor) 1 includes: a rotor 3 fixed to a rotating shaft 2; a stator 7 in which a stator core 8 arranged to surround the rotor 3 and a permanent magnet 12 forming a field magnetomotive force generating unit are equipped with a coil 11 forming a torque generating driving unit; and a case 13 that accommodates the rotor 3 and stator 7. Note that when the case 13 is formed of a magnetic body, a magnetic flux of the permanent magnet 12 flows into the case 13, resulting in making a contribution to torque difficult; thus, it is preferable that the case 13 is formed of a non-magnetic body.

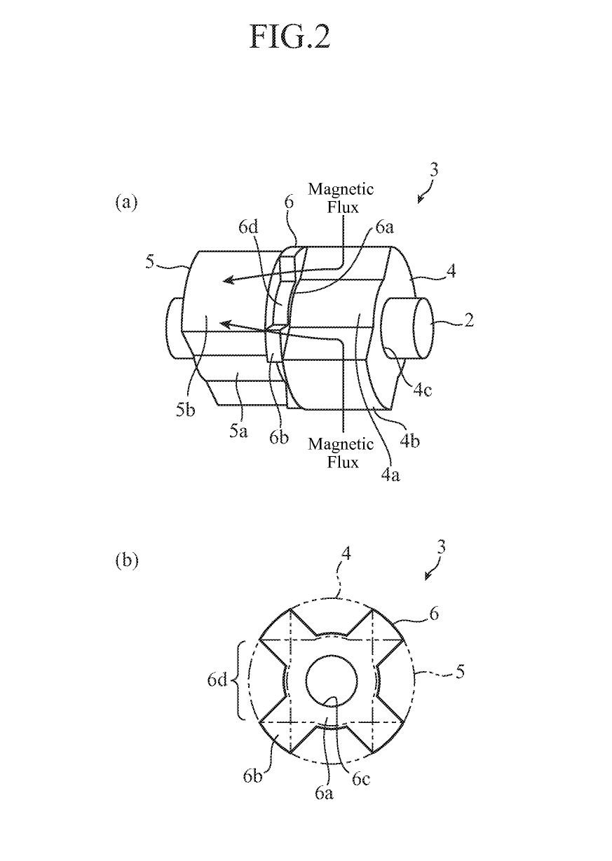

FIG. 2(a) illustrates an enlarged perspective view of the rotor 3, and FIG. 2(b) illustrates a plan view of a partition wall 6.

The rotor 3 includes: a first magnetic body 4 and a second magnetic body 5 manufactured by laminating and integrating a plurality of magnetic steel plates formed in a predetermined shape in an axial direction of the rotating shaft 2; and a partition wall 6 in which an insertion hole 6c for insertion of the rotating shaft 2 is bored in a plate-like magnetic member.

The first and second magnetic bodies 4 and 5 are manufactured in approximately the same shape, and include: cylindrical bases 4a and 5a having insertion holes 4c and 5c (insertion hole 5c illustrated in FIG. 1) for insertion of the rotating shaft 2 at axial center positions thereof; and salient poles 4b and 5b protrusively provided outward in a radial direction from outer circumferential surfaces of the bases 4a and 5a, and each arranged by two at an equal angular pitch in a circumferential direction thereof. The first and second magnetic bodies 4 and 5 are configured as follows: they are arranged closely to each other to face each other through the partition 6 with the salient poles 4b and 5b shifted from each other by a half pitch in the circumferential direction, and are fixed to the rotating shaft 2 which is inserted into the insertion holes 4c and 5c.

The partition wall 6 includes: a disk-shaped base 6a in which the insertion hole 6c is bored; and four projections 6b arranged at an equal angular pitch in the circumferential direction and protrusively provided outward in the radial direction from the outer circumferential surface of the base 6a. In addition, notches 6d are respectively formed at four places between the projections 6b adjacent in the circumferential direction. An outer diameter of the base 6a is larger than an outer diameter of each of the base 4a of the first magnetic body 4 and the base 5a of the second magnetic body 5. An outer diameter of the projections 6b is identical to an outer diameter of each of the salient poles 4b of the first magnetic body 4 and the salient poles 5b of the second magnetic body 5. Further, the projection 6b is disposed between the salient pole 4b of the first magnetic body 4 and the salient pole 5b of the second magnetic body 5 when viewed from the axial direction. Furthermore, a thickness in the axial direction of the partition wall 6 is smaller than a thickness in the axial direction of the permanent magnet 12.

As illustrated in FIG. 1, the stator core 8 includes a first stator core 9 and a second stator core 10 which are manufactured by laminating and integrating a plurality of magnetic steel plates formed in a predetermined shape in the axial direction of the rotating shaft 2. The first and second stator cores 9 and 10 are manufactured in the same shape, and include: cylindrical core backs 9a and 10a; and teeth 9b and 10b protrusively provided inward in the radial direction from the outer circumferential surfaces of the core backs 9a and 10a, and each arranged by six at an equal angular pitch in the circumferential direction. The first and second stator cores 9 and 10 are disposed at positions to surround the first and second magnetic bodies 4 and 5 with circumferential positions of the teeth 9b and 10b aligned with each other. In addition, one coil 11 is wound around a pair of teeth 9b and 10b, and the end of the coil 11 are connected to a power distribution board (so-called bus bar) which is not shown. Further, the disk-shaped permanent magnet 12 is interposed between the core backs 9a and 10a, and the stator 7 and rotor 3 are positioned such that the permanent magnet 12 faces the partition wall 6.

Next, an operation of the electric motor 1 will be described.

As indicated by an arrow in FIG. 1, a magnetic flux of the permanent magnet 12 flows from the salient pole 5b of the second magnetic body 5 into the first stator core 9, and then flows in the axial direction to return from the second stator core 10 to the salient pole 4b of the first magnetic body 4, thereby exciting the salient poles 4b and 5b. On this occasion, because the salient poles 4b and 5b are shifted by a half pitch in the circumferential direction, the magnetic flux acts as if the N poles and S poles are disposed alternately in the circumferential direction when seen in the axial direction. On the other hand, when the energization of the coil 11 is switched, the S poles and N poles of the teeth 9b and 10b of the stator core 8 are switched. By doing so, the field magnetomotive force from the permanent magnet 12 and the current flowing through the coil 11 interact to generate torque, so that the rotor 3 is rotated in the circumferential direction.

Note that a field coil may be placed instead of the permanent magnet 12 to obtain the field magnetomotive force. In the case of the field coil, the case 13 is preferably formed of a magnetic body.

In addition, because the thickness in the axial direction of the partition wall 6 is smaller than the thickness in the axial direction of the permanent magnet 12, it is possible to suppress the occurrence of the flow of a magnetic flux which flows from the second stator core 10 to the first stator core 9 through the partition wall 6, and which does not contribute to the torque. In this way, a leakage magnetic flux can be reduced to secure large torque.

Next, an effect of the partition wall 6 interposed between the first magnetic body 4 and second magnetic body 5 will be described. In this case, it will be described by comparing the protrusive partition wall 6 of the present Embodiment 1 with a disk-shaped partition wall 20 proposed in the above Patent Document 1.

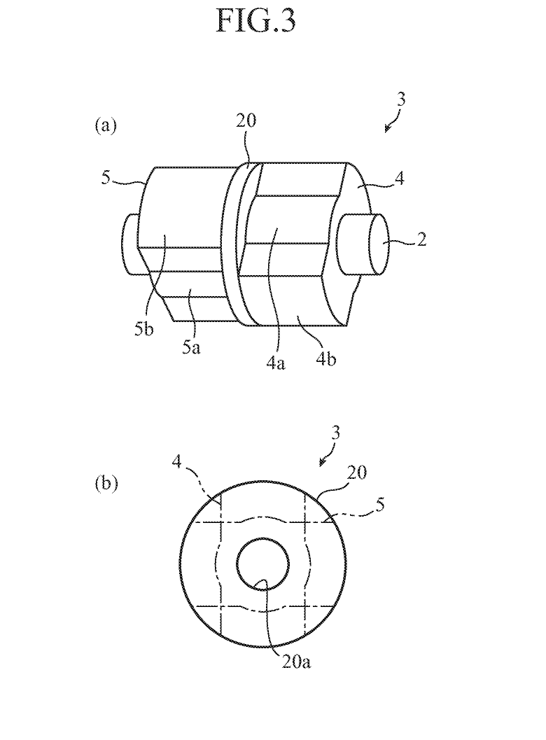

FIG. 3(a) illustrates a perspective view of a rotor 3 which uses the disk-shaped partition wall 20 proposed in the above Patent Document 1, and FIG. 3(b) illustrates a plan view of the partition wall 20. The partition wall 20 has an insertion hole 20a for insertion of a rotating shaft 2 formed in a disk-shaped magnetic body, and has the same outer diameter as the outer diameter of each of first and second magnetic bodies 4 and 5.

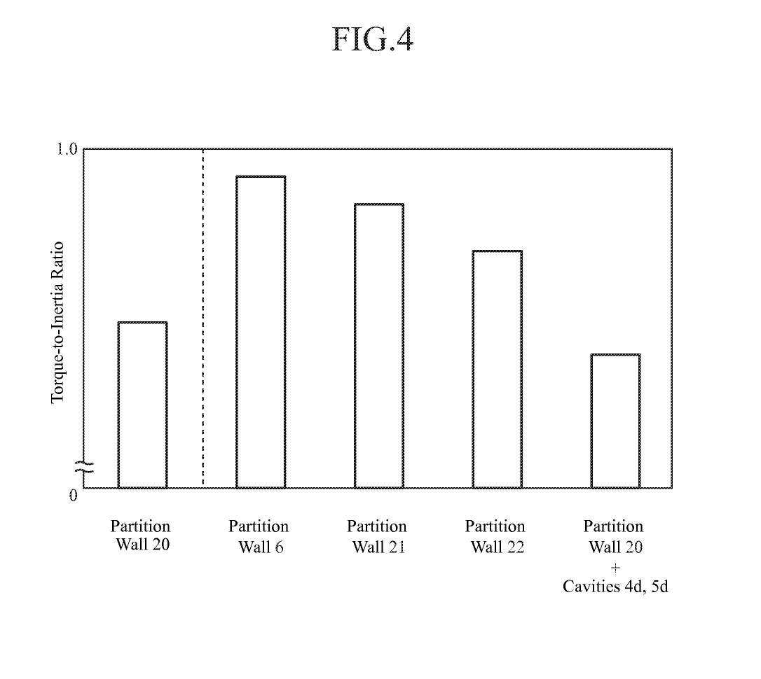

In addition, FIG. 4 illustrates results that measures torque-to-inertia ratios when the shape of the partition wall is changed. This represents as follows: the larger the torque-to-inertia ratio on the vertical axis of the graph, the higher the acceleration performance. Note that partition walls 21 and 22 and partition wall 20 plus cavities 4d and 5d will be described later.

Because the conventional partition wall 20 illustrated in FIG. 3 has the disk shape, whereas the partition wall 6 of the present Embodiment 1 illustrated in FIG. 2 is formed with the four notches 6d, and thus a weight thereof can be reduced by the notched percentage to thus reduce the inertia. Note that because the four projections 6b are formed in the same shape and arranged at the equal angular pitch, no runout of the shaft occurs when the rotor 3 is rotated at a high speed. Also, even when the four notches are formed, the projections 6b are present between the salient poles 4b and 5b, and thus the salient poles 4b and 5b are magnetically connected via the projections 6b. Because of that, as indicated by an arrow in FIG. 2(a), a magnetic path is formed as follows: a magnetic flux emerging from the stator 7 side goes in the salient pole 4b of the first magnetic body 4, flows into the salient pole 5b of the second magnetic body 5 via the projection 6b disposed between the salient pole 4b and salient pole 5b, and returns again to the stator 7 side. Further, since the outer diameter of the base 6a is formed larger than the outer diameter of each of the bases 4a and 5a, the protruding portion also functions as a magnetic path. Thus, the torque can be maintained without hindering the flow of the magnetic flux of the rotor 3.

Meanwhile, as disclosed in the above Patent Document 1, when the rotor 3 is rotated at a high speed, a whirling flow of air occurs between the salient poles 4b adjacent in the circumferential direction on the first magnetic body 4 side. Similarly, a whirling flow of air occurs between the salient poles 5b adjacent in the circumferential direction on the second magnetic body 5 side. On this occasion, because the salient poles 4b and 5b are present in the axial direction with shifted by the half pitch in the circumferential direction, if a member (namely the projection 6b of the partition wall 6) that blocks the space between the salient poles 4b and 5b is not present, the flow of air flowing in the axial direction by passing through between the salient poles 4b and 5b may occur, which may result in a windage loss.

However, in the present Embodiment 1, since the projections 6b of the partition wall 6 shield the space between the salient poles 4b and 5b, it is possible to block the flow of air flowing in the axial direction to thus reduce the windage loss, and consequently the torque can be maintained.

As described above, the partition wall 6 can reduce the windage loss to thus maintain the torque similarly to the partition wall 20, while it can reduces the inertia better than the partition wall 20, and thus the torque-to-inertia ratio is higher to thus improve the acceleration performance as illustrated in FIG. 4.

Incidentally, in FIG. 2, since gaps exist at four places between the salient poles 4b and 5b when seen in the axial direction, the four projections 6b are formed in the partition wall 6 corresponding to this number; thus, the projections 6b have only to be formed corresponding to the number of gaps between the salient poles 4b and 5b of the rotor 3 to be targeted.

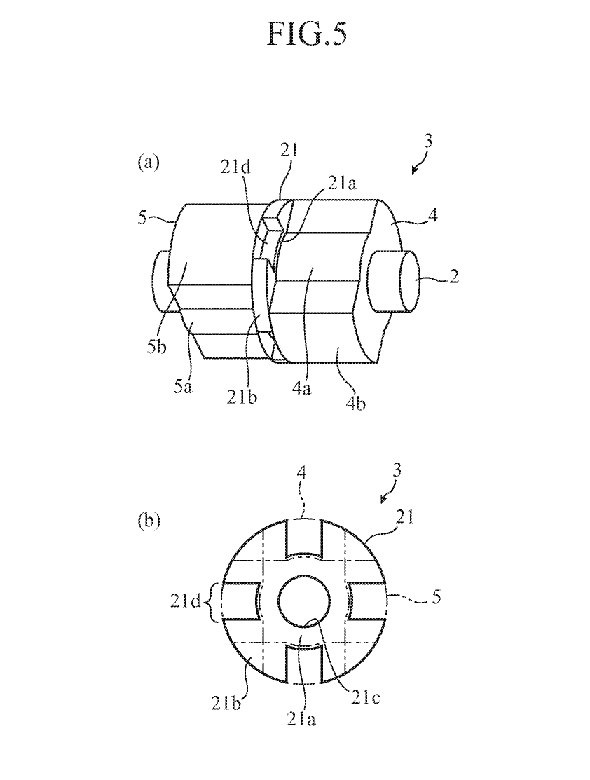

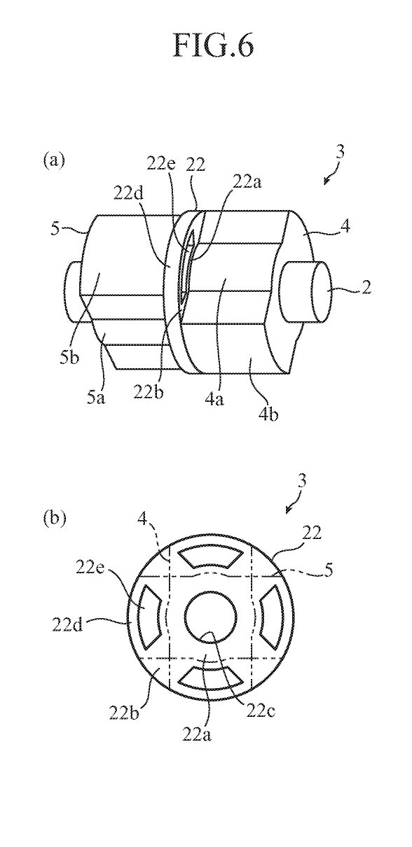

Next, modifications of the partition wall 6 will be described with reference to FIG. 5 and FIG. 6.

As illustrated in a perspective view of FIG. 5(a) and a plan view of FIG. 5(b), a partition wall 21 includes a disk-shaped base 21a having an insertion hole 21c for insertion of a rotating shaft 2, and four projections 21b arranged at an equal angular pitch in a circumferential direction, and each protrusively provided in a fan shape that expands as the projection goes outward in a radial direction from an outer circumferential surface of the base 21a.

Because the partition wall 21 is formed with notches 21d having a shape in which a disk is notched at four places like the partition wall 6 so as to achieve lightweight thereof, as illustrated in FIG. 4, it provides a larger inertia reduction effect, and a larger torque-to-inertia ratio as compared with the conventional disk-shaped partition wall 20. On the other hand, because the partition wall 21 has a larger volume than the partition wall 6 by an increase of the projections 21b expanding in the fan shape, it provides a slightly smaller inertia reduction effect, and a slightly smaller torque-to-inertia ratio as compared with the partition wall 6.

As illustrated in a perspective view of FIG. 6(a) and a plan view of FIG. 6(b), a partition wall 22 includes: a disk-shaped base 22a having an insertion hole 22c for insertion of a rotating shaft 2; four projections 22b arranged at an equal angular pitch in a circumferential direction thereof, and each protrusively provided outward in an radial direction from an outer circumferential surface of a base 22a; and four connection portions 22d connecting outer edges in the radial direction of the adjacent projections 22b.

Because the partition wall 22 is formed with holes 22e at four places in a disk to so as to achieve light weight thereof, as illustrated in FIG. 4, it provides a larger inertia reduction effect, and a larger torque-to-inertia ratio as compared with the conventional disk-shaped partition wall 20. On the other hand, since the partition wall 22 has a larger volume than the partition wall 6 by the formation of the connection portions 22d, and also has the connection portions 22d positioned on the outer edge of the partition wall 22, it provides a smaller inertia reduction effect, and a smaller torque-to-inertia ratio as compared with the partition wall 6.

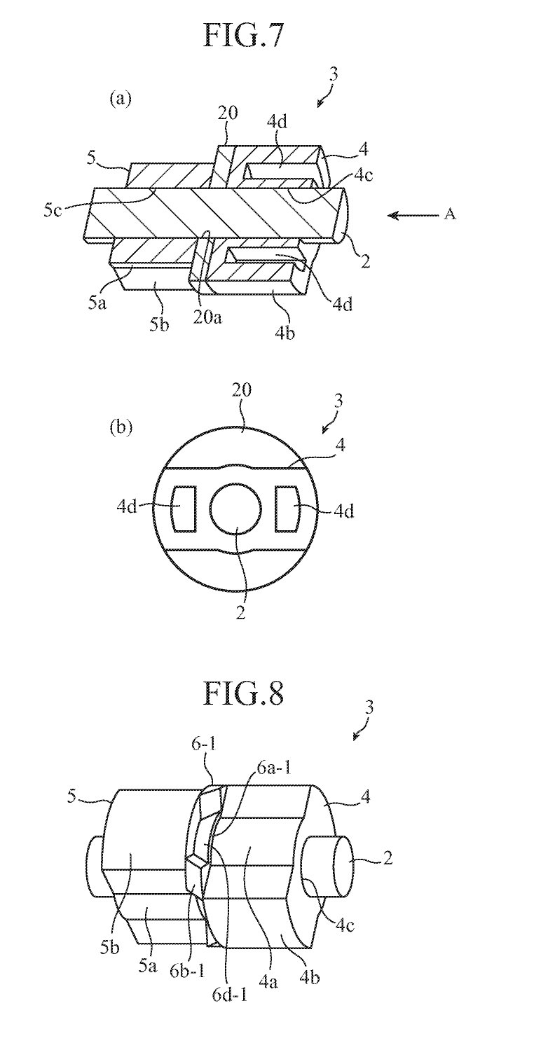

Additionally, as a reference example of the light weight, a configuration in which weights of the first and second magnetic bodies 4 and 5 are reduced instead of the partition wall 6, 21, and 22 is illustrated in FIG. 7.

As illustrated in a cross-sectional view of FIG. 7(a), and a view as seen from an arrow A of FIG. 7(b), a cavity 4d is formed in each of two salient poles 4b of a first magnetic body 4, and two cavities 5d (not illustrated) are also formed in a second magnetic body 5. In addition, a disk-shaped partition wall 20 that is the same as that in FIG. 3 is interposed between the first magnetic body 4 and the second magnetic body 5.

Because this rotor 3 has the first and second magnetic bodies 4 and 5 formed in a hollow structure so as to achieve light weight thereof, it can provide an inertia reduction effect, but a flow of magnetic flux is hindered by the cavities 4d and 5d to thus decrease torque thereof, and as a result, the torque-to-inertia ratio becomes smaller as illustrated in FIG. 4. For this reason, it is preferable to reduce the inertia by reducing the weight of the partition wall 6 instead of the first and second magnetic bodies 4 and 5.

From the above, according to Embodiment 1, the electric motor 1 includes: the rotor 3 including the first magnetic body 4 having the salient poles 4b provided protrusively at the equal angular pitch in the circumferential direction on the outer circumference of the cylindrical base 4a having the insertion hole 4c at the axial center position, the second magnetic body 5 having approximately the same shape as the first magnetic body 4, and arranged coaxially with each other's salient poles shifted in the circumferential direction and separated by a predetermined gap in the axial direction, and the partition wall 6 which is a plate-like member having the insertion hole 6c and which is interposed closely to each other between the first magnetic body 4 and the second magnetic body 5; the rotating shaft 2 fixed the first magnetic body 4, the second magnetic body 5, and the partition wall 6 with inserted into the respective insertion holes 4c, 5c, and 6c; and the stator 7 including the stator cores 8 that surround the first and second magnetic bodies 4 and 5, respectively, the permanent magnet 12 that excites the salient poles 4b and 5b of the rotor 3, and the coil 11 that generates rotational torque in the rotor 3, and the partition wall 6 is configured to have the notches 6d formed in a part other than a region sandwiched between the salient poles 4b of the first magnetic body 4 and the salient poles 5b of the second magnetic body 5 which are arranged at the shifted positions when seen in the axial direction.

Similarly, the partition walls 21 and 22 also respectively have the notches 21d and holes 22e formed in the part other than the region sandwiched between the salient poles 4b of the first magnetic body 4 and the salient poles 5b of the second magnetic body 5 which are arranged at the shifted positions when seen in the axial direction.

For this reason, with the formation of the notches 6d, 21d or the holes 22e, the volume thereof can be reduced to reduce the inertia. Moreover, since the partition wall 6, 21, or 22 is present in the gap between the salient poles 4b and 5b, the flow of air in the axial direction flowing from the first magnetic body 4 to the second magnetic body 5 through the gap between the salient poles 4b and 5b can be blocked to thus reduce the windage loss. Thus, it is possible to provide the electric motor 1 which reduces the inertia without impairing the windage loss reduction effect of the partition wall 6, 21, or 22.

In addition, according to Embodiment 1, the partition walls 6 and 21 are magnetic members, and respectively include: the disk-shaped bases 6a and 21a having the insertion holes 6c and 21c at the axial center positions; and the projections 6b and 21b protrusively provided at the equal angular pitch in the circumferential direction on the outer circumference of the bases 6a and 21a to have the shape to be notched between the projections 6b and 21b, and it is configured such that the projections 6b and 21b each are disposed between the salient poles 4b of the first magnetic body 4 and the salient poles 5b of the second magnetic body 5 which are arranged at the shifted positions when seen in the axial direction to magnetically connect the salient poles 4b and 5b. For this reason, it is possible to reduce the inertia without hindering the magnetic flux flowing through the rotor 3.

Further, according to Embodiment 1, the four projections 6b of the partition wall 6 have the same shape. Similarly, the four projections 21b of the partition wall 21 also have the same shape. For this reason, the runout of the shaft during rotation can be prevented; a preferable electric motor 1 can be provided to be used in an application which a high-speed rotation is required.

Furthermore, according to Embodiment 1, the outer diameter of the base 6a of the partition wall 6 is configured to be larger than each outer diameter of the bases 4a and 5a of the first and second magnetic bodies 4 and 5. Similarly, each outer diameter of the respective bases 21a and 22a of the partition walls 21 and 22 is also larger than each outer diameter of the bases 4a and 5a of the first and second magnetic bodies 4 and 5. For this reason, the magnetic paths formed in the bases 6a, 21a, and 22a are achieved, and it is thus possible to reduce the inertia without hindering the magnetic flux flowing through the rotor 3.

Moreover, according to Embodiment 1, the thickness in the axial direction of the partition wall 6 is smaller than the thickness in the axial direction of the permanent magnet 12. Similarly, the thickness in the axial direction of each of the partition wall 21 and 22 is also smaller than the thickness in the axial direction of the permanent magnet 12. For this reason, it is possible to reduce the leakage magnetic flux that does not contribute to the torque.

It is noted that in the present invention, a modification of arbitrary components in the embodiment or an omission of arbitrary components in the embodiment is possible within a range of the invention.

FIGS. 8 to 10 illustrate modifications of the partition wall 6. Note that in FIGS. 8 to 10, the same or equivalent part as/to those of FIG. 2 will be denoted by the same reference numerals, and redundant descriptions thereof will be omitted.

For example, as shown in a partition wall 6-1 illustrated in a perspective view of FIG. 8, it may be configured such that both ends of each of four projections 6b-1 are cut obliquely to an axial direction thereof to form a larger notch 6d-1 while securing a minimum magnetic path so as to achieve light weight thereof, and further reduce inertia thereof.

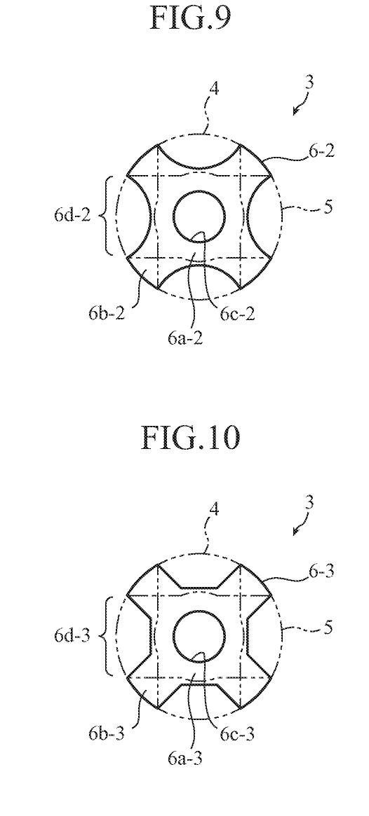

In addition, for example, as shown in a partition wall 6-2 illustrated in a plan view of FIG. 9, it maybe configured such that connection portions between a base 6a-2 and projections 6b-2 are formed in a curved shape, so that the connection portions hardly receive a stress during a high-speed rotation of the rotor 3.

Further, for example, as shown in a partition wall 6-3 illustrated in a plan view of FIG. 10, an outer circumferential surface of a base 6a-3 may be formed in a planar shape instead of a curved shape.

The above-described modifications can be also applied to the partition walls 21 and 22.

### INDUSTRIAL APPLICABILITY

As described above, because the electric motor according to the present invention enables the inertia to be reduced without impairing the windage loss reduction effect, it is suitable for use in a magnetic inductor type synchronous electric motor that rotatively drives the turbines of an electric compressor, an electrically assisted turbocharger, and the like at a high speed.

### EXPLANATION OF REFERENCE NUMERALS

1: Electric motor

2: Rotating shaft

3: Rotor

4: First magnetic body

4a, 5a: Base

4b, 5b: Salient poles

4c, 5c: Insertion holes

4d, 5d: Cavities

5: Second magnetic body

6, 6-1 to 6-3, 20 to 22: Partition walls

6a, 6a-1, 6a-2, 6a-3, 21a, 22a: Bases

6b, 6b-1, 6b-2, 6b-3, 21b, 22b: Projections

6c, 6c-1, 6c-2, 6c-3, 21c, 22c: Insertion holes

6d, 6d-1, 6d-2, 6d-3, 21d: Notches

7: Stator

8: Stator core

9: First stator core

9a, 10a: Core backs

9b, 10b: Teeth

10: Second stator core

11: Coil (Torque generating driving unit)

12: Permanent magnet (Field magnetomotive force generating unit)

13: Case

20a: Insertion hole

22d: Connection portion

22e: Hole.

1. An electric motor of a magnetic inductor type, comprising:
a rotor including a first magnetic body having salient poles provided protrusively at an equal angular pitch in a circumferential direction on an outer circumference of a cylindrical base having a rotating shaft insertion hole at an axial center position, a second magnetic body having approximately the same shape as the first magnetic body, and arranged coaxially with each other's salient poles shifted in the circumferential direction and separated by a predetermined gap in an axial direction, and a partition wall which is a plate-like member having a rotating shaft insertion hole and which is interposed closely to each other between the first magnetic body and the second magnetic body;
a rotating shaft fixed the first magnetic body, the second magnetic body, and the partition wall with inserted into the respective rotating shaft insertion holes; and
a stator including a stator core that surround the first and second magnetic bodies, a field magnetomotive force generating unit that excites the salient poles of the rotor, and a torque generating driving unit that generates rotational torque in the rotor,
wherein the partition wall has a hole or a notch formed in a part of the partition wall other than a region sandwiched between the salient poles of the first magnetic body and the salient poles of the second magnetic body which are arranged at shifted positions when seen in the axial direction.

2. The electric motor according to claim 1, wherein the partition wall is a magnetic member, and includes a disk-shaped base having the rotating shaft insertion hole at the axial center position, and projections protrusively provided at an equal angular pitch in the circumferential direction on an outer circumference of the base to have a shape to be notched between the projections, and
the projections are disposed between the salient poles of the first magnetic body and the salient poles of the second magnetic body which are arranged at shifted positions when seen in the axial direction to magnetically connect the salient poles.

3. The electric motor according to claim 2, wherein the projections of the partition wall have the same shape.

4. The electric motor according to claim 2, wherein an outer diameter of the base of the partition wall is larger than an outer diameter of the base of each of the first and second magnetic bodies.

5. The electric motor according to claim 1, wherein the stator cores include a first stator core disposed at a position to surround the first magnetic body and a second stator core disposed at a position to surround the second magnetic body, and
the field magnetomotive force generating unit is interposed between the first and second stator cores and at a position to surround the partition wall, and
a thickness in the axial direction of the partition wall is smaller than a thickness in the axial direction of the field magnetomotive force generating unit.
